(19) United States
(12) Patent Application Publication
(10) Pub. No.: US 2014/0368434 A1
(43) Pub. Date: Dec. 18, 2014

(54) GENERATION OF TEXT BY WAY OF A TOUCHLESS INTERFACE

(71) Applicant: Microsoft Corporation, Redmond, WA (US)

(72) Inventors: Timothy S. Paek, Sammammish, WA (US); Johnson Apacible, Mercer Island, WA (US)

(21) Appl. No.: 13/916,606

(22) Filed: Jun. 13, 2013

(51) Int. Cl. G06F 3/01

(52) U.S. Cl. CPC G06F 3/017
USPC 345/168; 345/156

(57) ABSTRACT

Described herein are technologies that facilitate decoding a continuous sequence of gestures set forth in the air by a user. A sensor captures movement of a portion of a body of the user relative to a keyboard displayed on a display screen, and a continuous trace is identified based upon the captured movement. The continuous trace is decoded to ascertain a word desirably set forth by the user.

### BACKGROUND

Inputting text to a computing device without using a physical keyboard or a soft keyboard (e.g., where keys on a touch-sensitive display can be selected) can be challenging. For example, relatively recently, accessory devices for televisions, such as video game consoles, set top boxes, media streaming devices, and the like, have been configured to receive textual input and perform a processing operation based upon such textual input. In an example, an accessory device that streams media can receive a textual query, perform a search over available media based upon the query, and output search results located during the search.

To provide such a query, however, a user typically employs a control device, such as a remote control, a video game controller, or the like, and selects characters one at a time by scrolling through a menu. Thus, if a user desires to set forth the query “movies,” the user individually selects each character from a list of characters presented on the display screen. While this may not be problematic for a relatively small amount of text, provision of a sequence of words may require a significant amount of time, causing the user frustration and decreasing usability of the accessory. Some accessories have been configured to receive and recognize voice input from the user. In noisy environments, however, such voice recognition may be suboptimal. In other examples, conventional remote controls are configured with a plurality of buttons, where each button represents multiple characters. The user can select a particular character by tapping a button an appropriate number of times. Again, however, provision of a relatively long sequence of characters can require pressing several buttons, wherein at least some of such buttons must be pressed numerous times.

Furthermore, accessory devices to televisions have been configured to transmit messages to and receive messages from other computing devices. Users are unlikely to employ a messaging application, however, if entrance of characters takes a relatively large amount of time or is somewhat cumbersome.

### SUMMARY

The following is a brief summary of subject matter that is described in greater detail herein. This summary is not intended to be limiting as to the scope of the claims.

Described herein are various technologies pertaining to identifying a word that is desirably set forth by a user through recognition of a continuous trace set forth by the user in the air. In an example, a user may be viewing a television screen and may be, therefore, displaced from such television screen. A sensor is configured to capture movement of at least one portion of a body of the user, wherein the portion of the body of the user, for example, may be an arm, a hand, a finger, a head, or the like. The user can move the portion of her body to form a continuous trace. For instance, the user may extend her arm towards the display screen and pivot her arm to form a continuous trace, wherein the continuous trace may be in a user-defined plane (e.g., which is substantially parallel to the display screen). This continuous trace is analogous to a user setting forth strokes over a canvas. A word or words may correspond to the continuous trace, and such word or words can be recognized based at least in part upon the continuous trace. Accordingly, a user can enter text by way of gestures made in the air.

In an exemplary embodiment, a keyboard can be presented on the display screen, wherein the keyboard can be invoked responsive to an invocation gesture. For example, various sensors can monitor action of a user, and an invocation gesture can be identified based upon data output by such sensors. Accordingly, an invocation gesture may be the user positioning herself at a particular location, the user making a gesture with her hand, the user setting forth a voice command, etc. Responsive to detecting the invocation gesture, a keyboard can be presented on the display screen, wherein the keyboard comprises a plurality of character keys, each character key being representative of at least one respective character. In an exemplary embodiment, a user can define size of the keyboard based upon at least one gesture. For instance, the user may draw a rectangle in the air, and the keyboard can be displayed on the display screen in accordance with the size of the rectangle drawn by the user. In another embodiment, the keyboard can be displayed at a standard size.

The user may then move the portion of her body relative to the keyboard, and can employ a continuous sequence of gestures to generate text. In a non-limiting example, the user may desire to set forth the text “hello.” The user can point her finger at a key on the keyboard that is representative of the letter “h,” and may thereafter move her arm, hand, and/or finger to form a continuous trace that passes over keys in the keyboard that are representative of the characters “e,” “l,” and “o.” In an example, graphical data can be displayed on the display screen that provides feedback to the user regarding the location of her continuous trace over the keyboard. The continuous trace can then be decoded, such that the word “hello” is identified as being desirably set forth by the user. At least one processing function can be undertaken responsive to the word being identified including, but not limited to, display of the word to the user, provision of the word to a computer-executable application, transmittal of the word as a portion of a message to another computing device, etc.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a user setting forth a gesture that can be decoded to ascertain a word desirably set forth by the user.

FIG. 2 is a functional block diagram of an exemplary system that facilitates decoding a continuous sequence of gestures set forth by a user in connection with identifying a word that is desirably set forth by the user.

FIG. 3 is a functional block diagram of an exemplary decoder component that can be employed in connection with decoding a sequence of strokes set forth by a user.

FIGS. 4 and 5 illustrate exemplary keyboards with a sequence of strokes thereover.

FIG. 6 illustrates an exemplary keyboard displayed on a display screen and potential words that correspond to a shape set forth by a user relative to keys of the keyboard.

FIG. 7 depicts a graphical user interface that depicts a sequence of hand-written characters set forth in the air by a user.

FIG. 8 is a flow diagram that illustrates an exemplary methodology for identifying a word based upon a continuous trace set forth by a user relative to a display screen.

FIG. 9 is a flow diagram that illustrates an exemplary methodology for identifying a continuous trace relative to keys of a keyboard displayed on a display screen in connection with identifying a word.

FIG. 10 is an exemplary computing system.

### DETAILED DESCRIPTION

Various technologies pertaining to identifying continuous traces undertaken relative to keys of a keyboard and recognizing words based upon such continuous traces are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

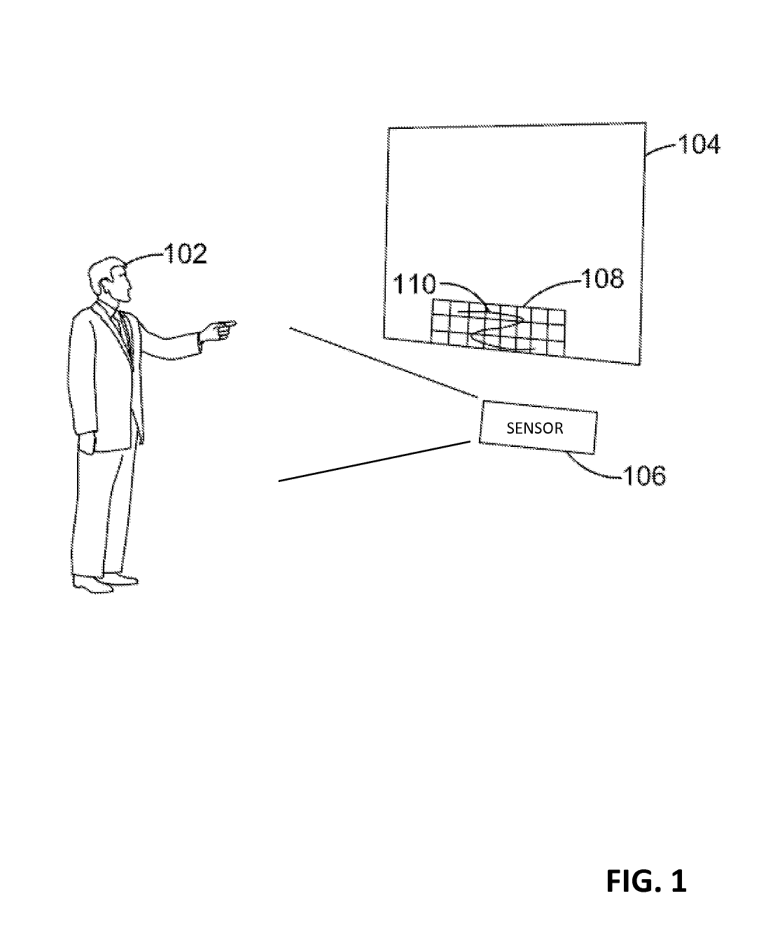

With reference now to FIG. 1, an exemplary depiction of 100 of a user 102 interacting with content shown on a display screen 104 is illustrated. The display screen 104 may be any suitable display screen, including a television display screen, a projected display, a computer display screen, etc. A sensor 106 is configured to capture movement of at least a portion of the body of the user 102 relative to the sensor 106 (and thus, relative to the display screen 104). For example, the sensor 106 can be configured to capture movement of an arm of the user 102, a hand of the user 102, a finger of the user 102, a head of the user 102, etc. Thus, the sensor 106 may be or include a camera, a plurality of cameras (such that stereoscopic analysis can be employed to identify location of portions of the user 102 relative to the sensor 106), a depth sensor (which may be a time of flight sensor, an infrared camera and associated software, etc.), a microphone, or other suitable sensing device. While shown as being external to the display screen 104, it is to be understood that the sensor 106 may be embedded in the display screen 104 or included as a portion of a housing that houses the display screen 104.

In the example shown in FIG. 1, a keyboard 108 is displayed on the display screen 104, wherein the keyboard 108 comprises a plurality of character keys, each character key being representative of at least one respective character. For instance, characters represented in the keyboard 108 may be arranged such that the keyboard 108 is a QWERTY keyboard, may be arranged alphabetically, etc. Further, the keyboard 108 may be configured to display characters in multiple different languages (English, Japanese, Chinese, etc.). A desired language of characters represented by respective keys in the keyboard 108 can be identified by the user 102 interacting with the keyboard 108 by way of the sensor 106.

In the example shown in FIG. 1, the user 102 can move her arm/hand relative to keys of the keyboard 108 to form a continuous trace 110 (in the air) over the keys of the keyboard 108. It can be ascertained that the user 102 is displaced from the display screen 104, in that the user need not physically contact the display screen 104 to form the continuous trace 110 over the keyboard 108. Rather, position of the continuous trace 110 relative to the keyboard 108 is ascertained through analysis of data output by the sensor 106. Additionally, the continuous trace 110 is continuous in nature, in that the user 102 need not cease movement of her arm/hand over particular keys in the keyboard 108 to cause a character corresponding to such key to be selected. Instead, the user 102 can perform a sequence of continuous gestures, thereby creating the continuous trace 110 over keys of the keyboard 108 that are included in a word desirably set forth by the user 102.

In an exemplary embodiment, the user 102 may wish to generate text for provision to an application, transmittal to a contact of the user 102, to perform a search, etc. As will be described in greater detail herein, the user 102 can invoke the keyboard 108 by performing a predefined action, which can cause the keyboard 108 to be displayed on the display screen 104. Thereafter, the user 102 can move a particular portion of her body relative to keys on the keyboard 108 that are representative of characters included in a word desirably set forth by the user 102. For example, if the user 102 wishes to set forth the word “hello”, the user 102 can move her arm/hand to form a continuous trace that connects a key that is representative of the letter “h” to a key that is representative of the character “e,” from the key that is representative of the character “e” to a key that is representative of the character “l,” and from the key that is representative of the character “l” to a key that is representative of the character “o.” It is to be understood that the continuous trace 110 may pass over other keys that are representative of characters not included in the word desirably set forth by the user 102. The continuous trace 110, however, can be decoded to decipher the word that is desirably set forth by the user 102, and such word can be displayed on the display screen 104.

Pursuant to an example, visual feedback can be provided to the user 102, wherein a graphical trail is shown over the keyboard 108 that is representative of the continuous trace 110 performed by the user 102. In summary then, the user 102 can perform natural, continuous gestures in the air, and words desirably set forth by the user 102 can be determined based upon such natural gestures.

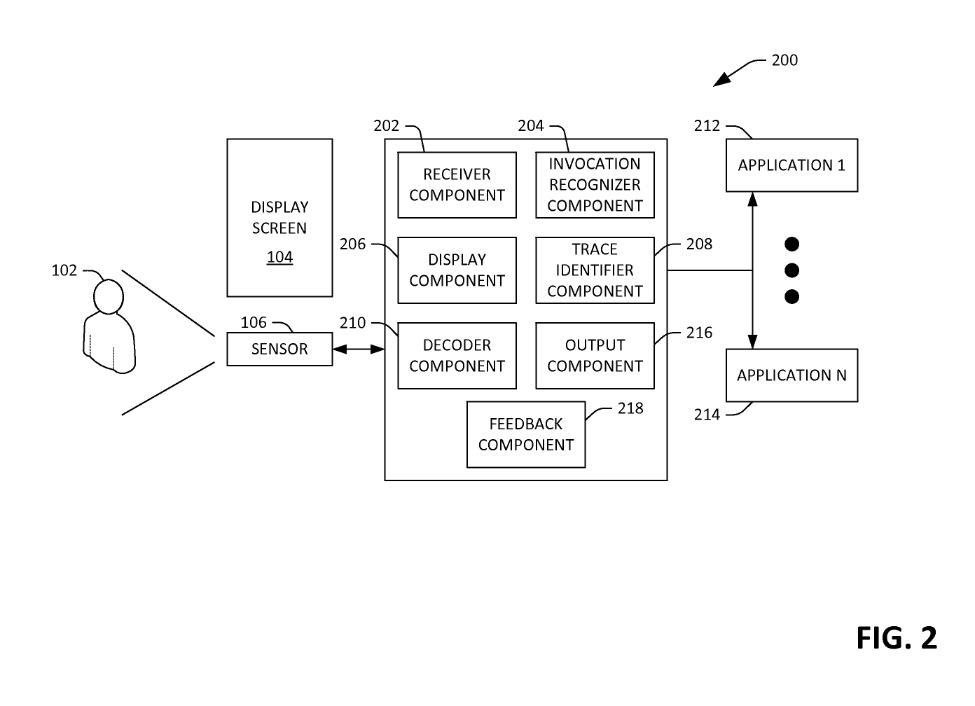

With reference now to FIG. 2, an exemplary system 200 that facilitates decoding a continuous trace set forth by the user 102 relative to the display screen 104 to ascertain a word that is desirably set forth by the user 102 is illustrated. In an exemplary embodiment, the system 200 can be included in an accessory that is in communication with a television, such as a video game console, a set top box, a streaming media device, a DVD player, a Blu-ray player, or the like. In another example, the system 200 may be included directly in a display apparatus, such as a television. In still yet another exemplary embodiment, the system 200 may be included in a server that is in communication with the display screen 104 (or an accessory apparatus that is in communication with the display screen 104), such that the system 200 is included as a portion of a web-accessible service (e.g., a cloud-bases service). The system 200 includes a receiver component 202 that receives data output by the sensor 106, the data being indicative of, for example, location of the user 102 relative to the display screen 104, as well as movement of at least a portion of a body of the user 102 relative to the display screen 104. For instance, the sensor 106 can be a camera that outputs images, wherein the images include data that is indicative of the location of the user 102 relative to the display screen 104, as well as movement of a portion of the body of the user 102 (e.g. the arm, hand, finger, head, . . . ) relative to the display screen 104. Additionally, as mentioned above, the sensor 106 may include other types of sensors, such as a depth sensor, a microphone, or the like.

The system 200 further includes an invocation recognizer component 204 that is in communication with the receiver component 202. The invocation recognizer component 204 can recognize an invocation command set forth by the user 102 based upon data output by the sensor 106. The user 102 can set forth such invocation command when she desires to generate text. The invocation recognizer component 204 can be configured to recognize at least one of a variety of different types of invocation commands. For instance, the invocation recognizer component 204 can be configured to recognize a spoken gesture set forth by the user 102, which indicates that the user 102 desires to set forth text. In another example, the invocation recognizer component 204 can recognize positioning of a body of the user 102 in a certain region relative to the sensor 106 as an invocation command. Still further, the invocation recognizer component 204 can recognize a particular gesture set forth by the user 102 as the invocation command. Exemplary types of invocation commands that can be recognized by the invocation recognizer component 204 are set forth below.

The system 200 also includes a display component 206 that is in communication with the invocation recognizer component 204. The display component 206 causes a keyboard to be displayed on the display screen 104 responsive to the invocation recognizer component 204 recognizing an invocation command set forth by the user 102. In an exemplary embodiment, the display component 206 can display the keyboard with a size and/or at a position on the display screen 104 based upon the invocation command determined by the invocation recognizer component 204.

Once the user 102 sees the keyboard on the display screen 104, the user 102 can set forth a continuous trace, which is a movement of at least a portion of the body of the user 102 relative to the keyboard shown on the display screen 104. In an exemplary embodiment, the keyboard shown by the display component 206 includes a plurality of character keys, wherein each character key is representative of a single respective letter. Such keyboard may appear similar to what is shown on a conventional physical keyboard. In another example, the keyboard shown by the display component 206 may be a compressed keyboard that includes a plurality of character keys, wherein each character key is representative of a respective plurality of characters. Thus, for instance, a first key may be representative of the characters, “Q,” “W,” and “E,” while a second key may be representative of characters “R,” “T,” and “Y.” The keyboard may also include other keys, including a “Spacebar” key, an “Enter” key, a numerical keyboard, etc.

The system 200 further comprises a trace identifier component 208 this is in communication with the receiver component 202, wherein the trace identifier component 208 identifies a continuous trace set forth by the user 102 based upon the movement of the portion of the body of the user 102 captured in the data output by the sensor 106. Thus, for example, the user 102 can move her hand in a continuous manner relative to keys of the keyboard shown on the display screen 104, and such continuous trace can be recognized by the trace identifier component 208. Additionally, to assist the user 102 in setting forth the continuous trace over appropriate keys of the keyboard, the display component 206 can provide visual feedback to the user 102 in the form of a graphical trail, which depicts the continuous trace over the keyboard. Thus, for example, the user 102 can initially position the portion of her body to correspond to first a key on the keyboard, the first key representing a first character in a word desirably set forth by the user 102. The user 102 can then move the portion of her body, and the display component 206 can graphically display the continuous trace set forth by the user 102 on the display screen 104, such that the user 102 can see which keys of the keyboard are being passed over when the user 102 is performing the continuous trace.

The trace identifier component 208 can be configured to identify beginning and ending points of a continuous trace set forth by the user 102. In an exemplary embodiment, the trace identifier component 208 can detect a gesture set forth by the user 102 that indicates that the continuous trace has started and/or stopped. For instance, the user 102 can open her hand when setting forth the continuous trace and may close her hand in a first when the continuous trace is completed. The trace identifier component 208 can recognize such gesture, such that the beginning and ending points of the continuous trace can be identified. In another example, the trace identifier component 208 can recognize voice commands set forth by the user 102 that indicates the start and/or stop of a continuous trace. In still yet another example, the user 102 can employ a first portion of her body to perform the continuous trace and may use a second portion of her body to indicate the start and/or stop of the continuous trace. For instance, the user 102 can use her right hand to perform the continuous trace and can use a gesture with her left hand to identify when the continuous trace is to start and/or stop.

Further, in another exemplary embodiment, the trace identifier component 208 can identify a continuous trace set forth by the user 102 based upon an entity to which the user 102 is pointing. In other words, the continuous trace is defined by the entity to which the user 102 is pointing instead of or in addition to the movement of the portion of the body of the user 102.

The system 200 further comprises a decoder component 210 that receives the trace identified by the trace identifier component 208 and decodes such trace to identify a word that is desirably set forth by the user 102. In an exemplary embodiment, the decoder component 210 can comprise a statistical decoder that probabilistically selects a word based upon the continuous trace set forth by the user 102. For instance, a continuous trace set forth by the user 102 can be converted to her intended word or sequence of words, wherein the statistical decoder takes into account both how likely it is that those strokes were produced by a user intending such words (e.g., how well the strokes match the intended word), and how likely those words are, in fact, the words intended by the user (e.g., “chewing gum” is more likely than “chewing gun”).

A plurality of applications 212-214 can be in communication with the system 200. Such applications 212-214 may include, for example, a word processing application, a text messaging application, a search application (that receives a word or set of words set forth by the user 102 and performs or executes a search over contents of a data repository based upon such word(s)). The system 200 can additionally comprise an output component 216 that outputs a word output by the decoder component 210 to at least one of the applications 212-214. Additionally, the display component 206 can cause a word output by the decoder component 210 to be displayed on the display screen 104, wherein the user 102 can confirm that the decoder component 210 has correctly decoded the continuous trace or can indicate that the decoder component 210 has incorrectly decoded the continuous trace.

The system 200 can further comprise a feedback component 218 that provides the user 102 with additional feedback pertaining to operation of the decoder component 210 and/or the trace identifier component 208. For example, the feedback component 218 can cause a speaker (not shown) to output audio data that is indicative of aspects of the continuous trace identified by the trace identifier component 208. For example, the feedback component 218 can output data that is indicative of a velocity of movement of the portion of the body of the user 102, acceleration of the movement of the portion of the body of the user 102, direction of movement of the portion of the body of the user 102, angular velocity/acceleration of the portion of the body of the user 102, etc. The feedback component 218 can provide such feedback to assist the user 102 in connection with developing muscle memory when setting forth continuous traces corresponding to words. Types of feedback that can be provided via the feedback component 218 include auditory feedback, such as pitch, volume, certain sounds, etc. Accordingly, the user 102 can be provided with both visual and auditory feedback pertaining to a continuous trace set forth by the user 102 to assist the user 102 in developing muscle memory for continuous traces.

Actions that can be undertaken by the invocation recognizer component 204 are now set forth in greater detail. The invocation recognizer component 204 can be configured to recognize certain gestures and/or voice commands performed/output by the user 102 that indicate when the user 102 wishes to set forth a continuous trace. In an exemplary embodiment, the user 102 can set forth a command that defines a particular location relative to the sensor 106, wherein when the user 102 is at such position, the user 102 wishes to set forth a continuous trace to generate text. Accordingly, when the invocation recognizer component 204 receives data output by the sensor 106 that indicates that the user 102 is in the predefined location, the invocation recognizer component 204 can recognize that the user 102 desires to generate text through continuous strokes.

In another example, the user 102 can define a virtual input region. For example, the user can set forth a command (e.g., voice, gesture, or the like) that indicates a desire to begin generating text by way of a continuous sequence of gestures (e.g., in the air). The user 102 may then define a virtual input region, for instance, by drawing a square input region in the air with a particular finger. The sensor 106 can output data that is indicative of the position of the virtual input region, and the boundaries of the input region can be recognized by the invocation recognizer component 204. The display component 206 can cause the keyboard to be displayed such that it corresponds with the boundaries of the input region defined by the user 102. Thus, the keyboard is shown on the display screen 104 to fit the size of the input region defined by the user 102.

The depth of the plane defined by the input region can be utilized by the trace identifier component 208 to identify when the user 102 desires to set forth a continuous trace. For instance, when the finger of the user is within some threshold distance from such plane (and inside the boundaries of the input region), the trace identifier component 208 can recognize a movement as a portion of a continuous trace. In yet another exemplary embodiment, the user 102 may desire to use position of her head to set forth continuous traces. In such an embodiment, the user 102 can define a square input region near her head (based upon movement of her head, definition of the input region via hands or a finger, etc.). When the head of the user 102 is in such input region, the invocation recognizer component 204 can recognize such action as being an invocation, causing the trace identifier component 208 to interpret movements of the head of the user 102 as a portion of a continuous trace.

In still yet another exemplary embodiment, the user 102 can define an input region near her head, and the invocation recognizer component 204 can recognize that the user 102 desires to set forth a continuous trace when the user 102 enters the input region. Thereafter, the trace identifier component 208 can be configured to identify direction of gaze of the eyes of the user 102, such that the user 102 can employee eye gaze to generate continuous traces (e.g., where a blink can indicate a start and stop of the trace). Further, the trace identifier component 208 can identify when the continuous trace has completed based upon depth data output by the sensor 106. For instance, the user 102 can position her hand near the input region noted above when performing the continuous trace, and can move her hand out of the input region when the continuous trace has completed (e.g., move her hand closer to or further away from the display screen 104 and/or the sensor 106).

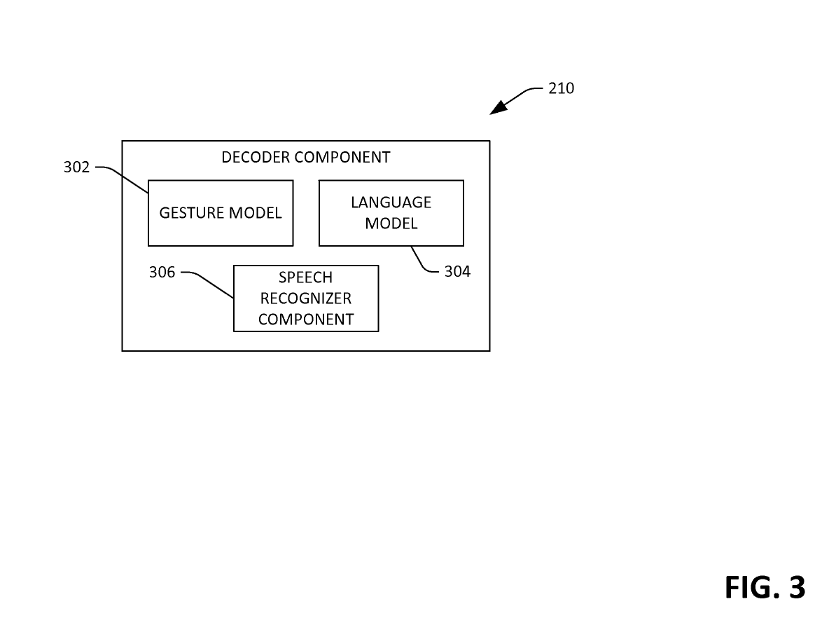

With reference now to FIG. 3, a functional block diagram that illustrates content of the decoder component 210 is illustrated. The decoder component 210 comprises a gesture model 302, a language model 304, and a speech recognizer component 306. As noted above, the decoder component 210 can decode continuous traces set forth by the user 102, thereby identifying words desirably set forth by the user 102. In connection with performing such decoding, the gesture model 302 can be trained using labeled words and corresponding continuous traces (e.g., in the air) set forth by users. With more particularity, during a data collection/model training phase, a user can be instructed to set forth a continuous trace in the air, relative to a keyboard shown on a display screen that is displaced from such user. Position of the continuous trace can be assigned to the word, and such operation can be repeated for multiple different users and multiple different words. As can be recognized, variances can be learned and/or applied to traces for certain words, such that the resultant gesture model 302 can relatively accurately model sequences of strokes for a variety of different words in a predefined dictionary.

Furthermore, the decoder component 210 can optionally include a language model 304 for a particular language, such as English, Japanese, German, or the like. The language model 304 can be employed to probabilistically disambiguate between potential words based upon previous words set forth by the user and/or the language modeled by the language model 304.

The speech recognizer component 306 can be configured to receive spoken utterances of the user 102 and recognize words therein. In an exemplary embodiment, the user 102 can verbally output words while performing a continuous trace relative to the keyboard shown on the display screen 104, such that the spoken words supplement the continuous trace and vice versa. Thus, for example, the gesture model 302 can receive an indication of a most probable word output by the speech recognizer component 306 (where the spoken word was initially received from a microphone) and can utilize such output to further assist in decoding a continuous trace set forth in the air by the user 102. In another embodiment, the speech recognizer component 306 can receive a most probable word output by the gesture model 302 based upon a continuous trace identified by the trace identifier component 208, and can utilize such output as a feature for decoding the spoken word. The utilization of the speech recognizer component 306, the gesture model 302, and the language model 304, can enhance accuracy of decoding continuous traces.

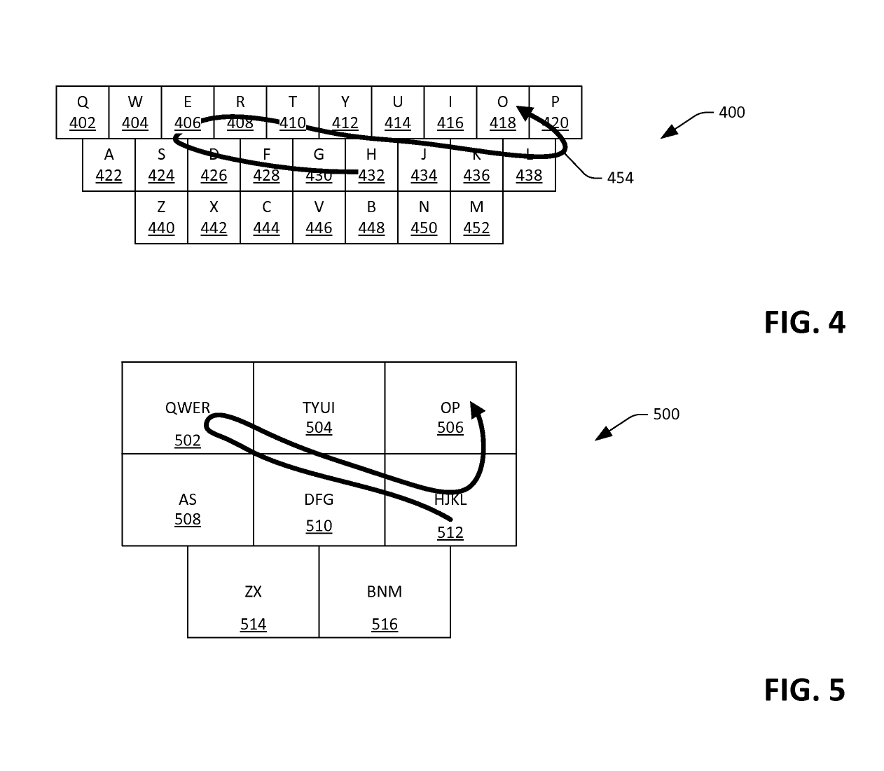

Now referring to FIG. 4, an exemplary keyboard 400 that can be displayed on the display screen 104 when the invocation recognizer component 204 ascertains that the user 102 desires to generate text by way of a continuous trace is illustrated. The keyboard 400 includes a plurality of keys 402-452, shown here is being arranged in accordance with a QWERTY keyboard. Responsive to the invocation recognizer component 204 determining that the user 102 wishes to set forth a continuous trace, the display component 206 can display the keyboard 400 on the display screen 104. The user 102 may desirably generate the word “hello” via a continuous trace made in the air relative to the keyboard 400. The user 102 can position the portion of her body relative to the display screen 104 such that the portion of her body corresponds with the key 432, which is representative of the letter “h.” The display component 206 can provide graphical feedback to the user 102 to assist the user 102 in positioning the portion of her body such that the continuous trace initiates at the key 432.

The user 102 may then continuously move the portion of her body from the key 432 to the key 406, which is representative of the character “e.” Without pausing at the key 406, the user 102 can cause the portion of her body to move such that the portion of her body transitions to correspond to the key 438, which is representative of the character “l.” Again, without pausing, the user 102 can move the portion of her body such that it corresponds with the key 418, which is representative of the character “o.” This movement of the body of the user 102 creates a continuous trace 454, which begins at the key 432, reaches the key 406, turns to reach the key 438, and then completes upon reaching the key 418. The trace identifier component 208 can recognize the continuous trace 454 based upon data output by the sensor 106. The decoder component 210 can decode the continuous trace 454 and identify the word “hello” that is desirably set forth by the user 102. The output component 216 can then output the word to at least one of the applications 212-214. While the keyboard 400 is shown as including only character keys, it is to be understood that the keyboard 400 may include other keys, such as, a “Spacebar” key, an “Enter” key, a numerical keypad, etc.

With reference now to FIG. 5, another exemplary keyboard 500 that can be displayed on the display screen 104 is illustrated. In contrast to the keyboard 400, the keyboard 500 is a condensed keyboard in that the keyboard 500 includes a plurality of character keys 502-516, and each character key is representative of a respective plurality of letters. For instance, in the exemplary keyboard 500, the keys 502, 504, and 512 are representative of four respective letters. The keys 510 and 516 are representative of three respective letters, and the keys 506, 508, and 514 are representative of two respective letters. The exemplary keyboard 500 may be particularly well-suited in connection with the system 200, since there are fewer keys in the keyboard 500, keys in the keyboard 500 can be shown as being relatively large on the display screen 104 (in comparison to keys of the keyboard 400), thereby allowing for an additional amount of error by the user 102 when setting forth a continuous trace.

Continuing with the example set forth above, the user 102 may desire to generate the word “hello” through a continuous trace. For instance, the invocation recognizer component 204 can recognize that the user 102 desires to generate text by setting forth a sequence of strokes with the body of the user 102. The user 102 may then position an appropriate portion of her body (e.g. an arm/hand), such that the portion of her body corresponds with the key 512, which is representative of the character “h.” For instance, the display component 206 can provide a visual indication that the arm of the user corresponds with the key 512. The user 102 may then move her arm from the key 512 to the key 502, which is representative of the character “e.” The user 102 may then move her arm, without pausing on the key 502, back to the key 512, which is representative of the character “l.” The user 102 may then pivot her arm upward such that it reaches the key 506, which is representative of the character “o.” By way of a gesture, moving out of the invocation region, etc., the user 102 can indicate that the continuous trace ceases at the key 506. The trace identifier component 208 can recognize a continuous trace 518 and the decoder component 210 can decode the continuous trace 518 to identify the word “hello.” The output component 216 may then output the word “hello” to at least one of the applications 212-214.

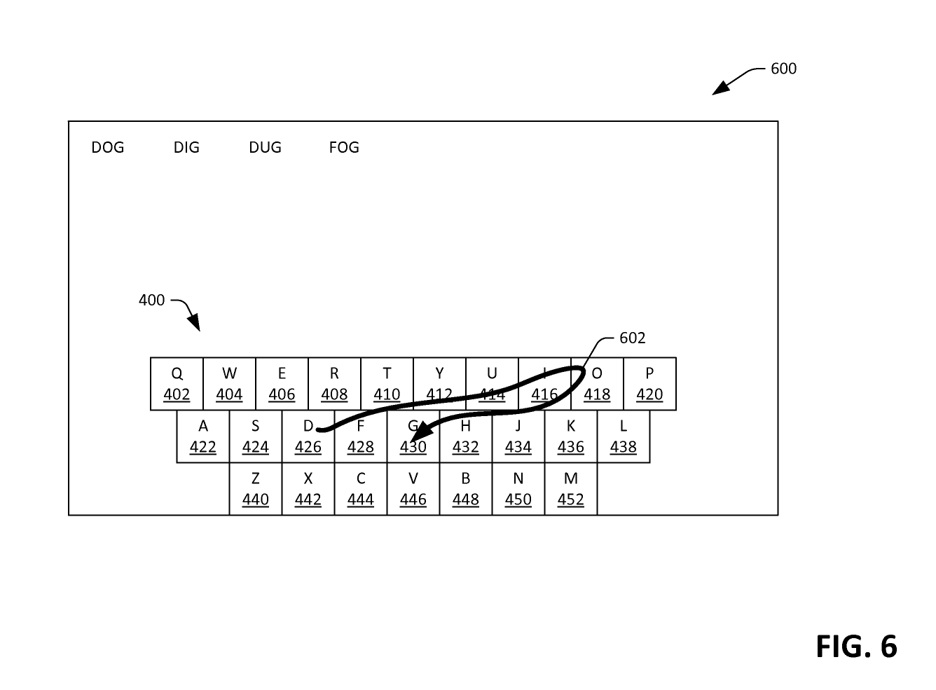

With reference now to FIG. 6, an exemplary graphical user interface 600 is illustrated. The graphical user interface 600 includes the keyboard 400. The user 102 desires to enter the word “dog,” and performs a continuous trace 602 that initiates at the key 426, then transitions to the key 418, and subsequently transitions to the key 430 (which are respectably representative of the characters “d,” “o,” and “g,” respectively). That is, through movement of a portion of her body, the user 102 connects the key 426 with the key 418, and the key 418 with the key 430.

As movement of the user 102 may be imprecise, however, the decoder component 210 can be configured to cause the display component to 206 to display a plurality of possible words corresponding to the continuous trace 602 set forth by the user 102. For instance, the decoder component 210 can identify the words “dog,” “dig,” “dug,” and “fog” as being the four most probable words that correspond to the continuous trace 602. The user may then indicate through voice command, gesture, or the like, that the word “dog” was the word desirably set forth by the user 102, thereby causing the output component 216 to output the word “dog” to at least one of the applications 212-214. Additionally, this information can be provided as feedback to the decoder component 210, such that operation of the decoder component 210 can improve as the user 102 continues to use the system 200.

While not shown, it is to be understood that marking menus can be utilized in connection with generation of text by way of gestures, wherein a marking menu refers to temporary presentation of a selectable key responsive to the user selecting a key on a virtual keyboard. For instance, a key on the keyboard 400 can represent a plurality of punctuation characters; when the user selects such key, a plurality of selectable keys can be displayed (e.g., as an overlay to the keyboard 400), wherein each key represents a respective punctuation character.

There are numerous techniques that can be employed to invoke a marking menu associated with a particular key. In an exemplary embodiment, the user can position the portion of her body such that it corresponds (e.g., points to) the particular key for some threshold amount of time. This can indicate a selection of the particular key, which can cause several other selectable keys to overlay the keyboard 400. If the user chooses not to select one of such selectable keys (e.g., the user points to a different portion of the keyboard 400), then the marking menu can cease to be displayed. The user 102 can select one of the selectable keys of the marking menu by, for instance, pointing to such key for a threshold amount of time, moving the portion of her body such that a continuous trace corresponding to such movement passes over the key, using a voice command, etc. In another exemplary embodiment, the user 102 can invoke the marking menu with respect to a particular key by way of a voice command. For example, the user may be generating a word through a sequence of gestures, and may wish to cause a semicolon to follow the word. To invoke an appropriate marking menu, while performing the sequence of gestures, the user 102 can say “punctuation” (for example), which can cause a marking menu to be presented. The user 102 may then select a key corresponding to the semicolon by pointing to such key, performing a gesture over such key, etc. In yet another exemplary embodiment, eye gaze tracking techniques can be used to invoke marking menus, wherein if the user 102 continuously looks at a particular key for a threshold amount of time, the marking menu is invoked.

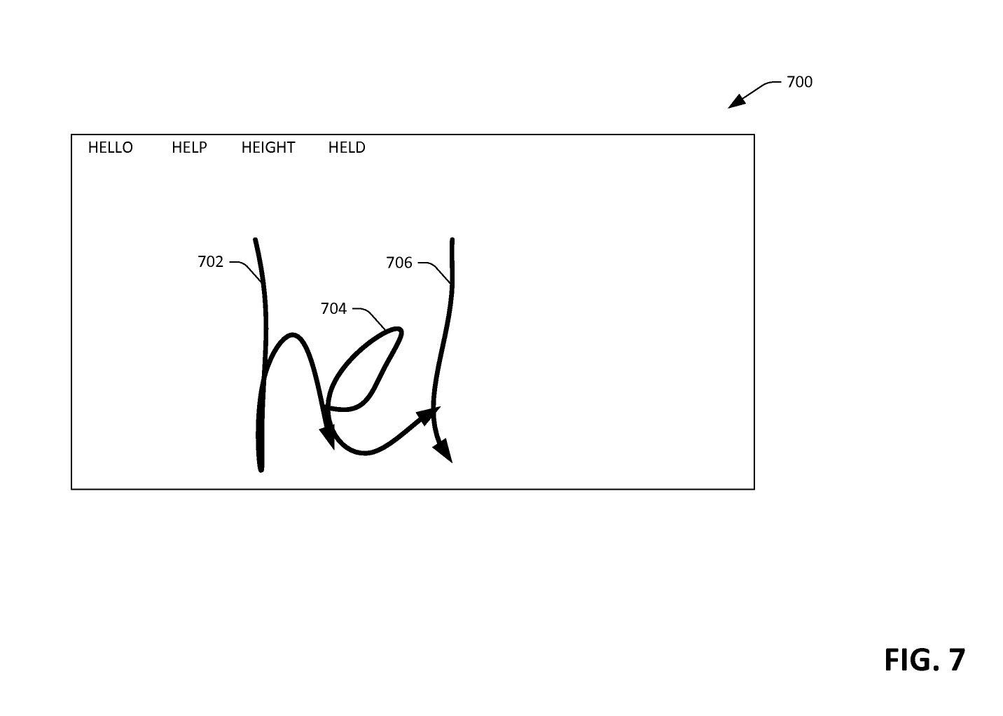

Turning now to FIG. 7, another exemplary graphical user interface 700 that can be presented to the user 102 is illustrated. In this example, rather than using a keyboard and setting forth a sequence of strokes over keys of the keyboard, the user 102 can indicate that she desires to handwrite letters to form one or more words. For instance, the user 102 can output a voice indication that is indicative of her desire to handwrite words in the air through movement of her arm/finger. The invocation recognizer component 204 can recognize such invocation, and the trace identifier component 208 can identify continuous traces set forth by the user 102. As shown in FIG. 7, such traces may be in the form of letters or a portion of a word desirably set forth by the user 102.

Again, in the example shown in FIG. 7, the user 102 desires to set forth the word “hello.” Thus, the user writes the letter “h” in the air, and can indicate a starting and stopping point of such letter. A continuous trace 702 illustrates the letter “h” set forth by the user 102. The user 102 may then perform a second continuous trace 704 by writing the letter “e” in the air, and may subsequently perform a third continuous trace 706 by writing the letter “l” in the air. The decoder component 210 can receive such continuous traces 702-706, and can decode the continuous traces to recognize the letters “h,” “e,” and “l.” The decoder component 210 may then ascertain some threshold number of most probable words corresponding to the continuous traces 702-706 set forth by the user 102. The display component 206 can display such words on the display screen, allowing the user to select an appropriate word without having to complete the word. Here, for example, the user can employ a gesture, voice command, or the like, to indicate that she desires to set forth the word “hello” (e.g., rather than the words “help,” height,” or “held”). This embodiment may be particularly well-suited for situations where a dictionary is not likely to include a word desirably generated by the user. For instance, the user 102 may desirably set forth a slang term, a particular name that is not included in a dictionary, etc.

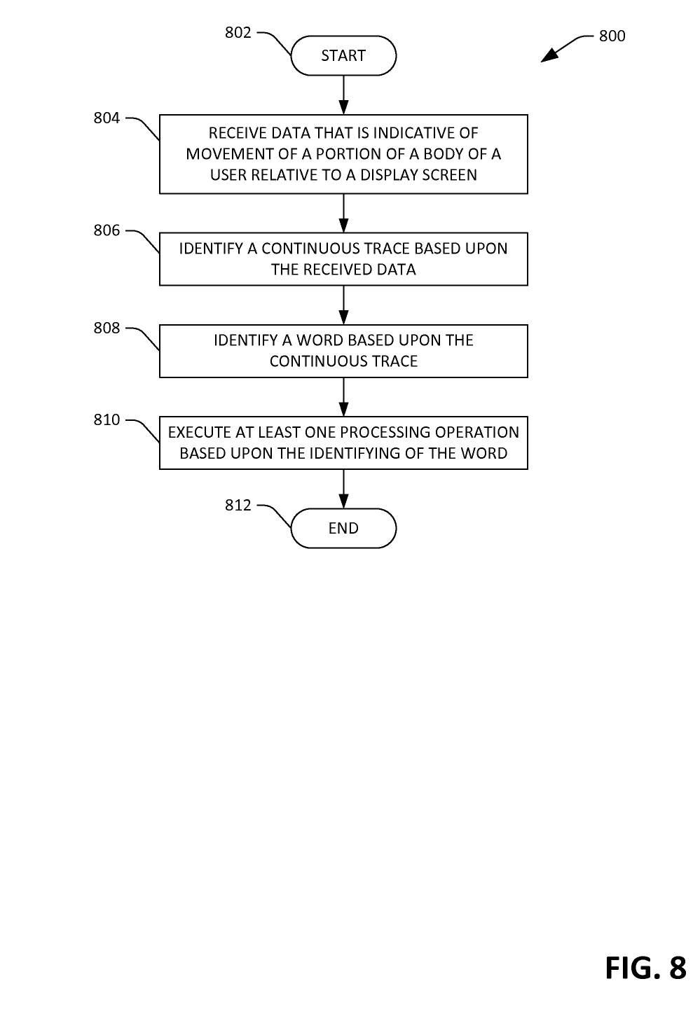

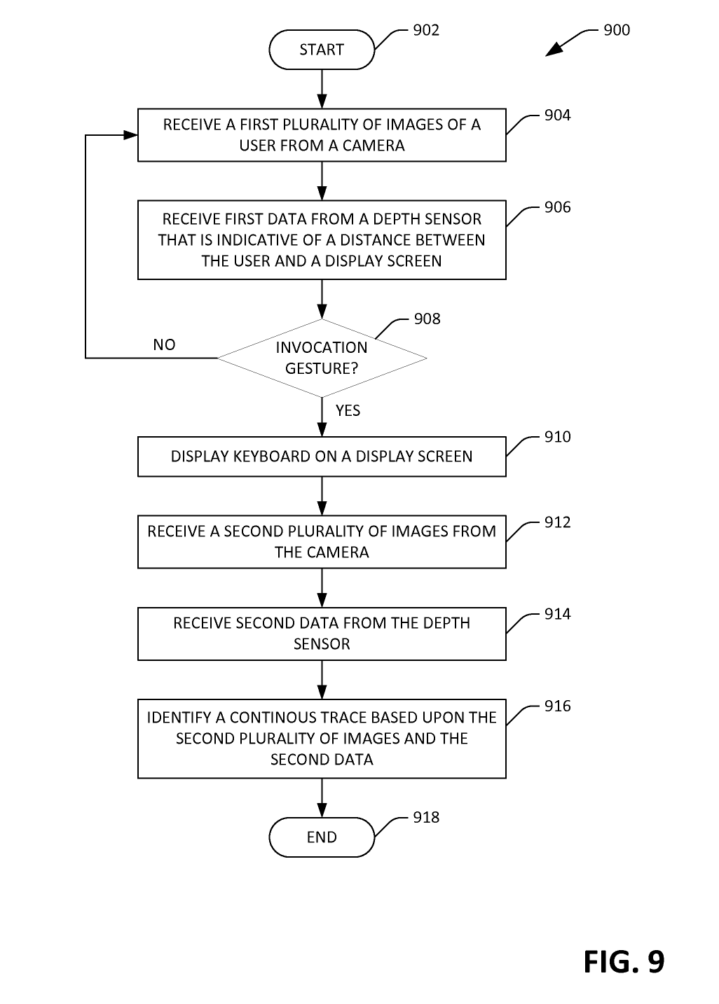

FIGS. 8-9 illustrate exemplary methodologies relating to use of a continuous sequence of gestures in the air to generate text. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

With reference now to FIG. 8, an exemplary methodology 800 that facilitates generating text by way of a sequence of strokes performed by a user with a portion of her body that is displaced from a display screen is illustrated. The methodology 800 starts 802, and 804 data that is indicative of movement of a portion of a body of a user relative to a display screen is received. As indicated above, the user is displaced from the display screen, and the movement of the portion of the body forms a continuous trace. In an exemplary embodiment, this continuous trace can be formed relative to character keys of a keyboard displayed on the display screen. In other embodiments, however, the keyboard need not be displayed on the display screen. For instance, a continuous trace may be perceived as a particular gesture that corresponds to a certain word.

At 806, responsive to receiving the data, a continuous trace is identified. At 808, a word is identified based at least in part upon the continuous trace, and 810 at least one processing function is executed based at least in part upon the identifying of the word. For instance, the at least one processing function may be displaying the word on the display screen. In another example, the at least one processing function can be outputting the word to an application executing on a computing device.

As indicated above, prior to identifying the continuous trace, an invocation command can be detected. Responsive to the detection of the invocation command, a keyboard can be displayed on a portion of the display screen, wherein the keyboard comprises a plurality of character keys; each character key in the plurality of character keys being representative of at least one respective character. Accordingly, the continuous trace is performed relative to character keys in the keyboard. Specifically, it can be detected that the continuous trace corresponds to the portion of the display screen where the keyboard is displayed. The word desirably set forth by the user can be identified based at least in part upon identifying a first key over which the continuous trace passes and identifying a second key over which the continuous trace passes. Therefore, the word that is identified comprises a first character that is represented by the first key and a second character that is represented by the second key. The methodology 800 completes at 812.

Now referring to FIG. 9, an exemplary methodology 900 that facilitates identifying a word desirably set forth by a user who is displaced from a display screen and/or physical keyboard is illustrated. The methodology 900 starts at 902, and at 904 a first plurality of images of a user are received from a camera, wherein the user is positioned to view a display screen. At 906, first data is received from a depth sensor that is indicative of a distance between the user and the display screen. The depth sensor may be a time of flight sensor, an infrared sensor, an ultrasound sensor, a radar sensor, or other suitable depth sensor. At 908, the first plurality of images and the first data are analyzed to ascertain if an invocation gesture has been recognized. The invocation gestures is a gesture that can be set forth by the user to indicate a desire of the user to generate text by way of a sequence of strokes made via movement of the body of the user. If an invocation gestures not detected based upon the first plurality of images and the first data from the depth sensor received a 904 and 906, respectively, then the methodology 900 returns to 904.

If, however, an invocation gesture is detected at 908 based upon the first plurality of images and the first data received from the depth sensor, then the methodology 900 proceeds to 910, where responsive to detecting the invocation gesture, a keyboard is displayed on the display screen, wherein the keyboard comprises a plurality of character keys; each character key being representative of at least one respective character.

At 912, a second plurality of images are received from the camera, wherein the second plurality of images capture movement of the user relative to the display screen. At 914, second data is received from the depth sensor, wherein the second plurality of images and the second data capture movement of an arm of the user relative to keys of the keyboard. This movement of the arm is continuous in nature in that the arm need not pause over keys that represent characters included in a word desirably set forth by the user.

At 916, a continuous trace is identified based upon the second plurality of images and the second data. At 918, a word is identified based upon the continuous trace, wherein the word includes a first character represented by a first character key over which the continuous trace passed and a second character represented by a second character key over which the continuous trace passed. The methodology 900 completes at 920.

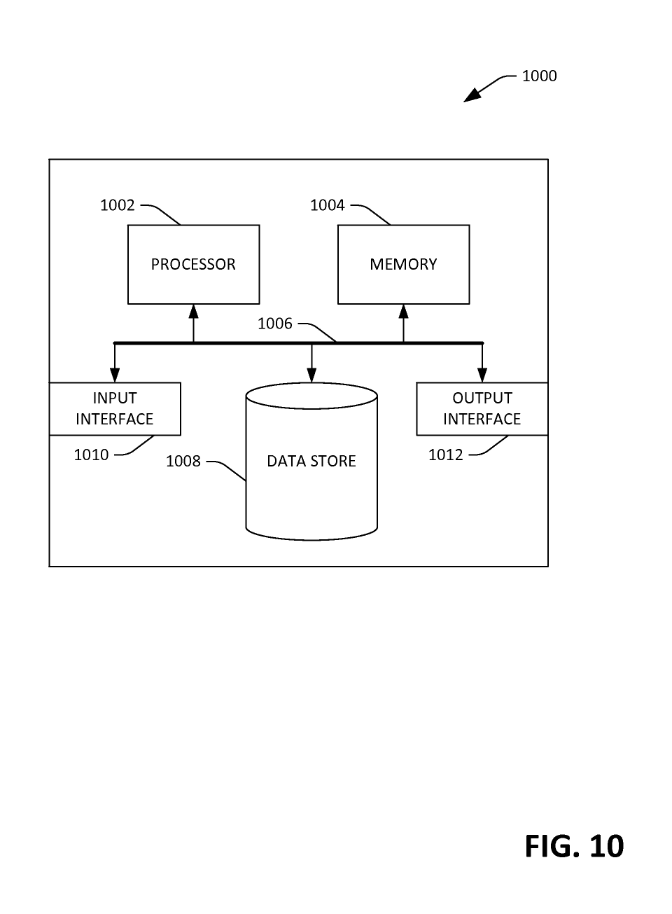

Referring now to FIG. 10, a high-level illustration of an exemplary computing device 1000 that can be used in accordance with the systems and methodologies disclosed herein is illustrated. For instance, the computing device 1000 may be used in a system that supports recognition of continuous traces set forth in the air by a user. By way of another example, the computing device 1000 can be used in a system that supports decoding of continuous traces. The computing device 1000 includes at least one processor 1002 that executes instructions that are stored in a memory 1004. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store language models, a gesture model, a dictionary, etc.

The computing device 1000 additionally includes a data store 1008 that is accessible by the processor 1002 by way of the system bus 1006. The data store 1008 may include executable instructions, imagery, language models, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

It is contemplated that the external devices that communicate with the computing device 1000 via the input interface 1010 and the output interface 1012 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1000 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1000 may be a distributed system. Thus, for instance, several devices may be in communication by way of a network connection and may collectively perform tasks described as being performed by the computing device 1000.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method, comprising:
receiving data that is indicative of movement of a portion of a body of a user relative to a display screen, the user being displaced from the display screen, the movement of the portion of the body forming a continuous trace;
responsive to receiving the data, identifying the continuous trace;
identifying a word based at least in part upon the continuous trace; and
executing at least one processing operation based at least in part upon the identifying of the word.

2. The method of claim 1, wherein the data that is indicative of movement of the portion of the body of the user relative to the display screen comprises images output by a camera.

3. The method of claim 2, wherein the data that is indicative of the movement of the portion of the body of the user relative to the display screen comprises data output by a depth sensor that is indicative of distance between the user and the displays screen.

4. The method of claim 3, further comprising detecting that the continuous trace has completed based upon the data output by the depth sensor.

5. The method of claim 1, further comprising:
displaying a keyboard on a portion of the display screen, the keyboard comprising a plurality of character keys, each character key in the plurality of character keys being representative of at least one respective character, wherein identifying the word comprises:
detecting that the continuous trace corresponds to the portion of the display screen where the keyboard is displayed;
identifying a first key over which the continuous trace passes; and
identifying a second key over which the continuous trace passes, wherein the word comprises a first character represented by the first key and a second character represented by the second key.

6. The method of claim 5, further comprising displaying graphical data on the display screen that is representative of the continuous trace, wherein the graphical data indicates that the continuous trace passed over the first key and the second key.

7. The method of claim 5, wherein the first key represents a first plurality of characters and the second key represents a second plurality of characters, and identifying the word comprises:
accessing a gesture model responsive to detecting that the continuous trace corresponds to the portion of the display screen where the keyboard is displayed; and
decoding the continuous trace to identify the word based upon the gesture model.

8. The method of claim 1, wherein the portion of the body of the user is an arm of the user.

9. The method of claim 1, wherein the portion of the body of the user is a finger of the user.

10. The method of claim 1, further comprising:
detecting a command that indicates that the continuous trace has been completed; and
identifying the word only after the command has been detected.

11. The method of claim 1, further comprising:
detecting a spoken utterance set forth by the user commensurate in time with continuous trace being identified; and
identifying the word based at least in part upon the spoken utterance set forth by the user and the continuous trace.

12. The method of claim 1, the at least one processing operation comprising transmitting the word to a computing device of another user as at least a portion of a message.

13. A system, comprising:
a processor; and
a memory that comprises a plurality of components that are executed by the processor, the plurality of components comprising:
a receiver component that receives images output by a camera, the images capturing movement of an arm of a user over time relative to a display screen;
a trace identifier component that identifies a continuous trace set forth by the user based upon the movement of the arm captured in the images output by the camera, the continuous trace corresponding to a continuous movement of the arm of the user;
a decoder component that identifies a word based upon the continuous trace identified by the trace identifier component; and
a display component that displays the word decoded by the decoder component.

14. The system of claim 13 comprised by a video game console.

15. The system of claim 13, wherein the receiver component additionally receives depth data output by a depth sensor, the depth data indicative of distance between the arm of the user and the display screen, the trace identifier component identifying the continuous trace based upon the depth data output by the depth sensor.

16. The system of claim 13, wherein the receiver component additionally receives audio data output by a microphone, the audio data comprising a spoken utterance of the user set forth commensurate in time with the continuous trace, the decoder component identifying the word based upon the spoken utterance of the user.

17. The system of claim 13, the plurality of components further comprising a trace identifier component that recognizes a gesture set forth by the user based upon the images output by the camera, wherein the trace identifier component identifies the continuous trace responsive to the trace identifier component recognizing the gesture

18. The system of claim 17, wherein the gesture comprises transition of a hand of the user from an open position to a closed position.

19. The system of claim 13, wherein the display component displays a keyboard on the display screen, the keyboard comprising a plurality of character keys, each character key representative of at least one respective character, the display component further displaying graphical feedback that is indicative of locations of the continuous trace over the keyboard displayed on the display screen.

20. A computer-readable storage medium comprising instructions that, when executed by a processor, cause the processor to perform acts comprising:
receiving a first plurality of images of a user from a camera;
receiving, from a depth sensor, first data that is indicative of a distance between the user and a display screen;
detecting an invocation gesture based upon the first plurality of images received from the camera and the first data received from the depth sensor;
responsive to detecting the invocation gesture, displaying a keyboard on the display screen, the keyboard comprising a plurality of character keys, each character key being representative of at least one respective character;
receiving a second plurality of images from the camera;
receiving second data from the depth sensor, the second plurality of images and the second data capturing movement of an arm of the user relative to the keyboard;
identifying a continuous trace based upon the second plurality of images and the second data; and
identifying a word based upon the continuous trace, the word comprising a first character represented by a first character key over which the continuous trace passed and second character represented by a second character key over which the continuous trace passed.
